(19) United States
(12) Patent Application Publication
(10) Pub. No.: US 2008/0302716 A1
(43) Pub. Date: Dec. 11, 2008

(54) Hollow Fiber Membrane Module and Method for Making Thereof

(75) Inventors: Soo-Hong Noh, Wonju City (KR); Oh-Sung Kwon, Seoul (KR); Hee-Sung Park, Kyunggi-do (KR)

Correspondence Address: SHERIDAN ROSS PC, 1560 BROADWAY, SUITE 1200, DENVER, CO, 80202, US

(73) Assignee: Industry-Academic Cooperation Foundation, Yonsei University, Seoul (KR)

(21) Appl. No.: 12/158,110

(22) PCT Filed: Dec. 19, 2006
(86) PCT No.: PCT/KR06/05565

§ 371 Date: Aug. 11, 2008

(30) Foreign Application Priority Data
Dec. 19, 2005 (KR) 10-2005-0125216

(51) Int. Cl. B01D 63/04; B01D 69/04

(52) U.S. Cl. 210/321.81

(57) ABSTRACT

The present invention relates to a hollow fiber membrane module. The hollow fiber membrane module includes a central water pipe, a central air pipe, and a plurality of small modules. The small modules include a plurality of housings, a hollow fiber membrane, a fixing part, a collector, and a diffusing unit. The housings are vertically provided with the central water pipe, connected to the inlet and the outlet, and arranged along an external circumferential surface of the central water pipe. The hollow fiber membrane is provided in the respective housings and performs water treatment by a pressure difference. The fixing part fixes a lower part of the hollow fiber membrane to the housing. The collector is formed in a lower part of the housing and communicated with an inner path of the hollow fiber membrane to collect water treated by the hollow fiber membrane and flow it to the inlet. The diffusing unit includes a lateral diffusing plate provided on an inner wall of the housing and having an air ejecting hole, and a central diffusing plate extending from the inner wall of the housing to a center of the housing and having an air ejecting hole.

### CROSS-REFERENCE TO RELATED APPLICATION

This application claims priority to and the benefit of Korean Patent Application No. 10-2005-0125216 filed in the Korean Intellectual Property Office on Dec. 19, 2005, the entire contents of which are incorporated herein by reference.

### BACKGROUND OF THE INVENTION

(a) Field of the Invention

The present invention relates to a hollow fiber membrane module using hollow fiber, and a hollow fiber membrane module manufacturing method. More particularly, the present invention relates to a hollow fiber membrane module for reducing contamination of an isolation layer and increasing water treatment efficiency by improving an application of Korean Patent No. 2004-0031362.

(b) Description of the Related Art

The inventor of the present invention has already provided a hollow fiber membrane module using hollow fibers and a method for manufacturing a hollow fiber membrane module in a filed application for a patent in Korea (Korean Patent No. 2004-0031362). The invention of the already-filed application, firstly, can enlarge the hollow fiber membrane module and divide the hollow fiber membrane module into a plurality of small modules. Secondly, the invention can uniformly coat a temporary fixing agent. Thirdly, the invention can easily control a temperature when a temporary or permanent fixing agent is hardened, reduce the use of the fixing agent, and minimize an energy loss. Fourthly, the invention can easily operate and easily repair the module when it is cut. Fifthly, the present invention can fix an upper part of the hollow fiber membrane when the module is manufactured, delivered, or repaired. Sixthly, the invention can prevent a counterflow of pollutants through a diffuser. Seventhly, the invention can individually control a water processing function of each small module when the plurality of small modules form one hollow fiber membrane module.

However, in the conventional hollow fiber membrane module, since air supplied into the small module from a diffusing plate tends to flow in a direction having a comparatively low pressure loss and therefore it flows to an empty space between a hollow fiber membrane and the diffusing plate, the conventional hollow fiber membrane module has a problem in that the air spouted from a spouting hole of the diffusing plate only flows through the space between the small module and a hollow fiber membrane.

Accordingly, the air supplied into the small module from the diffusing plate is dissipated while not affecting the hollow fiber membrane surface, and therefore it may not efficiently eliminate contamination of the hollow fiber membrane.

In addition, since the conventional hollow fiber membrane module is formed such that the hollow fiber membrane in the small module touches the diffusing plate, source water flowing into the small module may not reach the hollow fiber membrane positioned deep inside the small module.

Further, since a distance between the inlet of the small module and an end of the small module is further increased as the size of the module increases, contaminated waste water flowing through the inlet may not appropriately flow to the inside of the module.

Accordingly, the hollow fiber membrane positioned in a most inside area of the small module may not perform a role as an isolation layer, the water may not appropriately flow, and therefore a surface of the hollow fiber membrane is problematically contaminated.

In addition, since the contaminated hollow fiber membrane may not perform the role as the isolation layer and a normal hollow fiber membrane performs the role as the isolation layer, a load is increased and the normal hollow fiber membrane is also contaminated.

Accordingly, the inventor of the present invention improves the hollow fiber membrane module disclosed in Korean Patent No. 2004-0031362, and suggests a hollow fiber membrane module for reducing the contamination of the isolation layer and increasing water treatment efficiency, and a manufacturing method for increasing the size of the hollow fiber membrane module.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a hollow fiber membrane module for inducing a flow of air ejected through a diffusing plate to a hollow fiber membrane so as to minimize contamination of the hollow fiber membrane, and a hollow fiber membrane module manufacturing method. In addition, the present invention has been made in an effort to provide a hollow fiber membrane module for inducing source water to flow deeply into a small module, uniformly performing water treatment of an entire hollow fiber membrane, and preventing contamination (caused by source water stagnation) of the hollow fiber membrane. An exemplary hollow fiber membrane module according to an embodiment of the present invention includes a central water pipe, a central air pipe, and a plurality of small modules. The central water pipe includes a plurality of inlets formed along a circumference of the central water pipe to flow water through the central water pipe. The central air pipe is vertically provided in the central water pipe, extends to a lower surface of the central water pipe, and includes a plurality of outlets formed along a circumference of the central air pipe to flow air through the central air pipe. The plurality of small modules include a plurality of housings, a hollow fiber membrane, a fixing part, a collector, and a diffusing unit. The plurality of housings are vertically provided with the central water pipe, connected to the inlet and the outlet, and arranged along an external circumferential surface of the central water pipe. The hollow fiber membrane is provided in the respective housings and performs water treatment by a pressure difference. The fixing part fixes a lower part of the hollow fiber membrane to the housing. The collector is formed in a lower part of the housing and communicated with an inner path of the hollow fiber membrane to collect water treated by the hollow fiber membrane and flow it to the inlet. The diffusing unit includes a lateral diffusing plate that is provided on an inner wall of the housing and has an ejecting hole for ejecting air, and a central diffusing plate that extends from the inner wall of the housing to a center of the housing and has an ejecting hole for ejecting the air. The diffusing unit is communicated with the outlet to eject the air to the hollow fiber membrane. An inner side surface of an upper part of the housing is protruded inside the housing to form a protrusion part.

Accordingly, the air ejected from the lateral diffusing plate flows further inside by the protrusion part of the housing as the air flows to the upper part of the housing, it is concentrated at a surface of the hollow fiber membrane, and therefore efficiency of eliminating pollutants may be increased.

A direction of the air ejected through an ejecting hole formed in the diffusing plate is vertical to the hollow fiber membrane.

In addition, the protrusion part is protruded at least an amount greater than a thickness of the lateral diffusing plate. Accordingly, as the cross-section of the inner part of the housing 20 is reduced by the protrusion part, flow velocity is increased, contamination of the hollow fiber membrane is minimized, and falling of the hollow fiber membrane may be reduced.

The hollow fiber membrane module includes a path for inducing a flow of source water between the respective diffusing plates and the hollow fiber membrane in the housing.

Accordingly, the source water flowing through a source water inlet of the housing may flow further deeply inside the housing through a path between the diffusing plate and the hollow fiber membrane, and therefore all of the hollow fiber membrane may perform its function.

In an exemplary method for manufacturing a hollow fiber membrane module according to an embodiment of the present invention, a hollow fiber membrane is fixed to a housing by using a temporary fixing agent, an auxiliary unit having a width corresponding to a path is inserted between respective diffusing plates and a hollow fiber membrane of the housing, a permanent fixing agent is provided between the temporary fixing agent and the auxiliary unit, and the permanent fixing agent is hardened, the temporary fixing agent is eliminated, and the auxiliary unit is eliminated.

### BRIEF DESCRIPTION OF THE DRAWINGS

FIG. 1 is a perspective view of a configuration of a hollow fiber membrane module according to an exemplary embodiment of the present invention.

FIG. 2 is a cross-sectional side view representing a combining configuration of the hollow fiber membrane module according to the exemplary embodiment of the present invention.

FIG. 3 is a perspective view representing a small module of the hollow fiber membrane module according to the exemplary embodiment of the present invention.

FIG. 4 is a cross-sectional view of the small module shown in FIG. 3.

FIG. 5 shows a diagram of a configuration of a protrusion part according to another exemplary embodiment of the present invention.

FIG. 6 is a cross-sectional view of an arrangement configuration of the hollow fiber membrane in the small module according to the exemplary embodiment of the present invention.

FIG. 7 and FIG. 8 respectively show perspective views representing an auxiliary unit provided to a central diffusing plate.

FIG. 9 is a cross-sectional view representing the auxiliary unit provided in the small module according to the exemplary embodiment of the present invention.

FIG. 10 shows a graph representing a flow velocity increase according to a cross-section difference.

### DESCRIPTION OF REFERENCE NUMERALS INDICATING PRIMARY ELEMENTS IN THE DRAWINGS

| | |
|---|---|
| 10: | Hollow fiber membrane module |
| 11: | Small module |
| 12: | Central water pipe |
| 13: | Inlet |
| 14: | Central air pipe |
| 15: | Outlet |
| 20: | Housing |
| 21: | Hollow fiber membrane |
| 22: | Fixing part |
| 23: | Collector |
| 24: | Diffusing unit |
| 25: | Band |
| 26: | Source water inlet |
| 27: | Connecting hole |
| 28: | Central path |
| 29: | Lateral diffusing plate |
| 30: | Central diffusing plate |
| 31: | Ejecting hole |
| 70: | Protrusion part |
| 80: | Path |
| 90, 92: | Auxiliary unit |
| 91, 93: | Gap maintaining member |

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

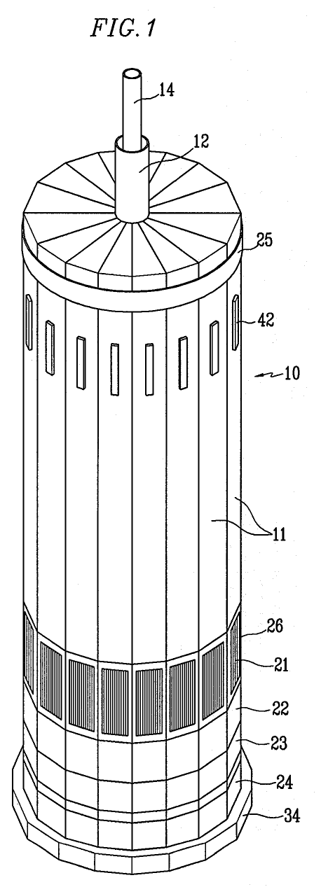

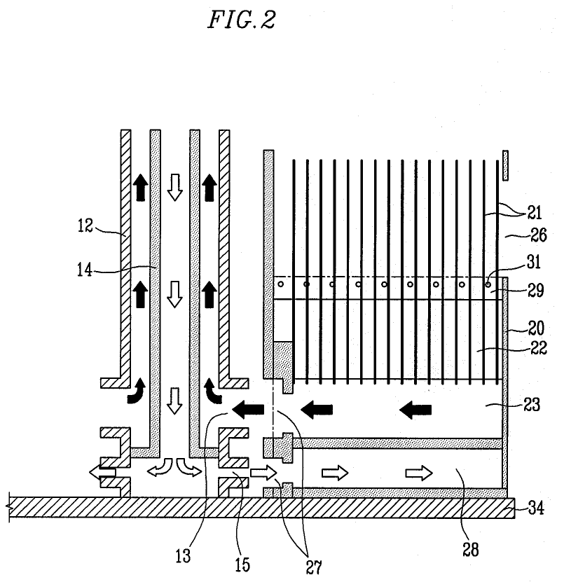

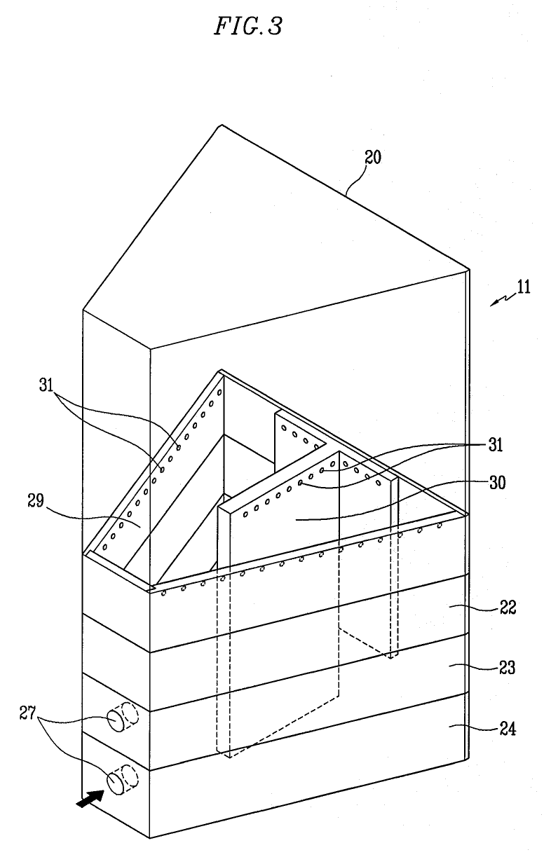

FIG. 1 is a perspective view of a configuration of a hollow fiber membrane module according to an exemplary embodiment of the present invention, FIG. 2 is a cross-sectional side view representing a combining configuration of the hollow fiber membrane module according to the exemplary embodiment of the present invention, and FIG. 3 is a perspective view representing a small module of the hollow fiber membrane module according to the exemplary embodiment of the present invention.

Firstly, the configuration of the hollow fiber membrane module will be described with reference to the figures.

The hollow fiber membrane module 10 includes a central water pipe 12, a central air pipe 14, and a plurality of hollow fiber membrane small modules 11. The central water pipe 12 is vertically provided in the hollow fiber membrane module 10, and an inlet 13 is formed along a circumference direction with a predetermined interval. The central air pipe 14 is vertically formed in the central water pipe 12 and extends to a lower surface of the central water pipe 12, and an outlet 15 is formed along the circumference direction at a lower of the central air pipe 14 so that air is supplied. The plurality of hollow fiber membrane small modules 11 are provided in a length direction of the vertically provided central water pipe 12, are connected to the inlet 13 and the outlet 15, and are arranged along an external circumferential surface of the central water pipe 12.

The small module 11 includes a housing 20, a hollow fiber membrane 21, a collector 23, a diffusing unit 24, and a fixing member. In the small module 11, a water treatment process is actually performed. The housing 20 forms an outer shape. The hollow fiber membrane 21 is positioned inside the housing in a length direction, and a lower part thereof is fixed to a fixing part 22 of the housing 20, so that the water treatment process is performed by a pressure difference. The collector 23 positioned at a lower part of the fixing part 22 of the housing 20 is communicated with the inlet 13 of the central water pipe 12 and is communicated with an internal path of the hollow fiber membrane 21 so as to collect water treated by the hollow fiber membrane 21. The diffusing unit 24 is positioned at the lower part of the housing 20 and is communicated with the outlet 15 of the central air pipe 14 so as to eject air to the hollow fiber membrane 21. The fixing member fixes an upper part of the hollow fiber membrane 21 that is a free end.

Here, the central water pipe 12 and the central air pipe 14 are disposed as a double tube. An inner tube is the central air tube 14 and an outer tube is the central water tube 12. Accordingly, the central air tube 14 (inner tube) is extended to the lower part of the central water pipe 12, and is communicated with the outlet 15 formed under the central water pipe 12. The inlet 13 formed at an upper part of the outlet 15 is communicated with the central water pipe 12.

The distance between the outlet 15 and the inlet 13 may be variable according to the size and the number of the small modules 11 (disposed along the circumferential surface). 12 or 24 small modules may be disposed according to the size thereof, and the outlets 15 and inlets 13 may be formed every 15 or 30 degrees in the circumferential direction.

The housing 20 forming the external shape of the small modules is made of acryl, PVC, etc. As shown in FIG. 1, the housing 20 is formed to have a trapezoid shape (an angle between two lateral side walls being 15-30 degrees), and is disposed in a fan-out direction of the central water pipe 12. Therefore, the small modules 11 are disposed in the circumferential direction of the central water pipe 12, such that a side wall of a small module contacts the side wall of other small modules.

In the housing 20, the plurality of hollow fiber membranes 21 are arranged in the length direction. The fixing part 22, the collector 23 (communicated with an inner path of the hollow fiber membranes 21), and the diffusing unit 24 are sequentially disposed in the lower part of the housing 20. The collector 23 and the diffusing unit 24 are respectively communicated with the inlet 13 and the outlet 15 of the central water pipe 12 through the connecting hole 27.

Therefore, each small module 11 is independently connected to the central water pipe 12, and if required, some small modules 11 can be removed from the central water pipe 12.

Here, airtight means (not shown) including packing means may be disposed at the respective connecting parts 27 formed in the housing 20 or the inlet 13 and the outlet 15 formed in the central water tube 12, so as to seal the contacting part 27.

Reference numeral 25 in FIG. 1 is a band for banding a plurality of the small modules 11 arranged along the central water pipe 12, and reference numeral 26 is a source water inlet that flows the source water into the housing 20. Reference numeral 34 is a lower supporting part for supporting weight of the small modules 11 and fixing them.

In addition, the collector 23 is a space communicated with the connecting hole 27 of the housing 20, and is provided under the fixing part 22 of the hollow fiber membrane 21. An end of the hollow fiber membrane 21 fixed in the fixing part 22 is extended to the collector 23, and the inner path of the hollow fiber membrane 21 is communicated with the collector 23.

That is, the fixing part 22 fixing the hollow fiber membrane 21 is mounted on the inner wall of the housing 20.

In addition, as shown in FIG. 3, the diffusing unit 24 includes a main path 28, a lateral diffusing plate 29, a central diffusing plate 30, and a plurality of ejecting holes 31. A main path 28 is provided at the lower part of the housing 20, and is communicated with the central air pipe 14 through the connecting hole 27 and the outlet 15. A lateral diffusing plate 29 is communicated with the main path 28, and extends upward from the fixing part 22, while having a space between the lateral diffusing plate 29 and an inner wall of the housing 20. The ejecting holes 31 are formed at a predetermined distance from each other on the lateral diffusing plate 29, and they eject air. The central diffusing plate 30 is communicated with the lateral diffusing plate 29, and is extended to the center of the housing 20. The ejecting holes 31 are formed at a predetermined distance from each other on the lateral diffusing plate 30 and eject air.

Therefore, the air flowing into the diffusing unit 24 is ejected to the central part of a bundle of the hollow fiber membrane 21 from the outer part thereof through the ejecting hole 31 of the lateral diffusing plate 29, and the air is ejected to the outer part of the bundle of the hollow fiber membrane 21 from the central part thereof through the ejecting hole 31 of the central diffusing plate 30.

Here, the ejecting hole 31 is formed on lateral surfaces of the respective diffusing plates 29 and 30 to horizontally eject air to the vertically positioned hollow fiber membrane 21.

Accordingly, the air may flow further deeply into the bundle of the hollow fiber membrane 21.

The lateral diffusing plate 29 extends along a lateral wall of the housing 20, while maintaining a predetermined space between the lateral diffusing plate 29 and the lateral wall of the housing 20. The lateral diffusing plate 29 has an open lower end communicated with the main path 28 of the diffuser 24 and a closed upper end exposed on the fixing part 22. Therefore, the air flowing into the main path 28 goes upward through the space between the lateral wall of the housing 20 and the lateral diffusing plate 29, and is ejected to the hollow fiber membrane 21 through the ejecting hole 31 formed in the lateral diffusing plate 29.

In addition, the central diffusing plate 30 has its own inner space. In a like manner of the lateral diffusing plate 29, the central diffusing plate 30 has an open lower end communicated with the main path 28 of the diffuser 24 and a closed upper end exposed on the fixing part 22, and the air flowing into the inner space of the central diffusing plate 30 is ejected to the hollow fiber membrane 21 through the ejecting hole 31 formed in both lateral sides of the central diffusing plate 30.

Here, the central diffusing plate 30 is formed to extend to the center of the housing 20 from the outer end thereof since the housing 20 is formed to have a trapezoid shape having different lengths of inner and outer walls radially formed from the central water pipe 12. The length of the central diffusing plate 30 (i.e., the length from the outer end of the housing 20 to the inner end of the central diffusing plate 30) is not specifically limited.

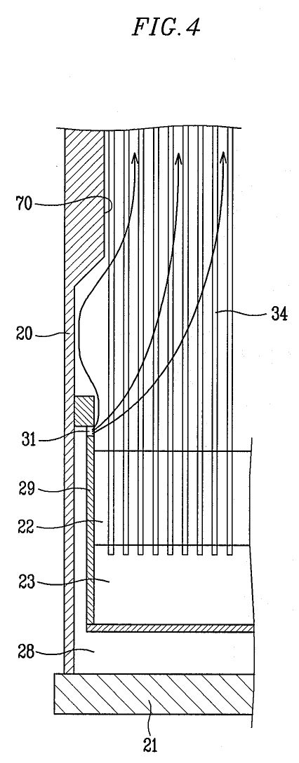

In the above hollow fiber membrane module according to the exemplary embodiment of the present invention, as shown in FIG. 4, the housing 20 includes a protrusion part 70. The protrusion part 70 is apart from an upper part of the lateral diffusing plate 29, and an inner side surface of the housing 20 is protruded.

An outer surface of the housing maintains its shape, and a thickness of the inner side surface is increased to form the protrusion part 70.

Since a slope is formed between the inner side surface of the housing 20 and the protrusion part 70, the air smoothly flows to the protrusion part 70 along the slope.

Therefore, the air ejected from the lateral diffusing plate 29 flows further inside by the protrusion part 70 of the housing 20 as the air flows to the upper part of the housing 20, it is concentrated at the surface of the hollow fiber membrane 21, and therefore efficiency of eliminating the contaminated materials may be increased.

A position of the protrusion part 70 is not limited when it is formed above the upper part of the lateral diffusing plate 29, and the lateral diffusing plate 29 may be formed to be 20 cm apart from the upper part of the lateral diffusing plate 29.

In addition, the protrusion part 70 extends to the upper part of the housing 20, and the thickness thereof is uniformly formed.

The thickness of the protrusion part 70 is not specifically limited. However, at least, it is protruded to extend more than the thickness of the lateral diffusing plate 29, so as to eliminate the space between the hollow fiber membrane 21 and the inner side surface of the housing 20.

In addition, an inner cross-section area of the housing 20 is reduced at an area in which the protrusion part 70 is formed.

Accordingly, the thickness of the protrusion part 70 may be defined by a cross-section ratio of the housing 20. That is, the protrusion part 70 is formed so that a cross-section ratio of the housing 20 in which the protrusion part 70 is not formed to the cross-section ratio of the housing 20 formed by the protrusion part 70 is 80 to 95%.

Since the protrusion part 70 is problematically protruded to the inside of the housing 20 when the thickness of the protrusion part 70 is formed to be less than the cross-section ratio of 80%, it places considerable pressure on the hollow fiber membrane 21 and disturbs the flow of air and water.

In addition, when the thickness of the protrusion part 70 is formed to be greater than the cross-section ratio of 95%, the protrusion part 70 is not appropriately protruded, and the air may not be appropriately induced.

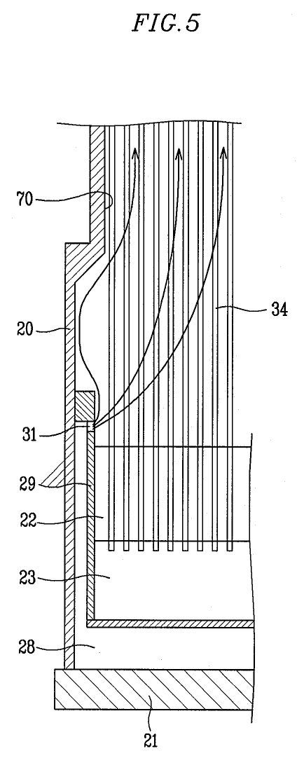

FIG. 5 shows a diagram of a configuration of the protrusion part 70 according to another exemplary embodiment of the present invention.

As shown in FIG. 5, the inner side surface of the housing 20 is protruded inside to form the protrusion part 70.

Upper and lower parts of the outer shape of the housing 20 respectively have two different sizes, and the inner side surface of the housing 20 is protruded inside by a difference between the sizes of the upper and lower parts to form the protrusion part 70.

The position and the protrusion of the protrusion part 70 is the same as that of the above-described exemplary embodiment of the present invention, and therefore detailed descriptions thereof will be omitted.

Since the cross-section of the housing 20 is reduced by the protrusion part 70 and the empty space between the inner side surface of the housing and the hollow fiber membrane 21 is not formed at the upper part of the lateral diffusing plate 29, the air ejected from the ejecting hole of the lateral diffusing plate 29 flows smoothly to the hollow fiber membrane 21, and the speed of the air and the source water flowing into the housing is improved. Therefore, the contaminated material on the surface of the hollow fiber membrane 21 may be further efficiently eliminated.

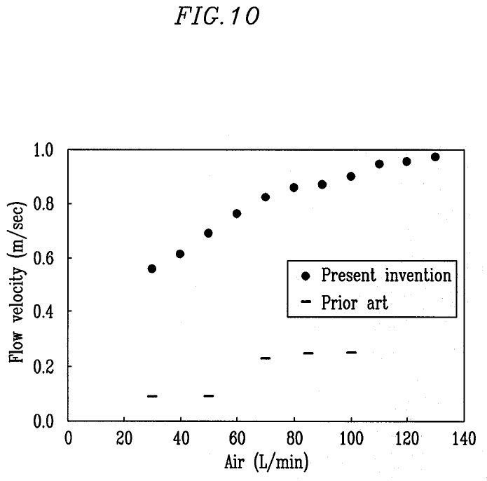

FIG. 10 shows a graph representing a flow velocity increase according to a cross-section difference. As shown in FIG. 10, when a cross-section area of the upper part of the housing 20 is reduced, the flow velocity is increased.

In the exemplary embodiment of the present invention, a hollow fiber membrane module having an entire exterior diameter of 750 mm is used, the air is supplied into the housing 20 at 80 l/min that is determined as an appropriate diffusing amount, and the thickness of the protrusion part 70 is formed as the cross-section ratio of 95%.

As shown in FIG. 10, the flow velocity is 0.25 m/sec in the conventional housing having the same cross-section, but it is increased by 40% (i.e., 0.34 m/sec) in the housing 20 having the protrusion part 70 in the exemplary embodiment of the present invention.

The flow velocity in the housing 20 is increased since the velocity of the air and water flowing to the surface of the hollow fiber membrane 21 is increased. As the flow velocity is increased, the contaminated material accumulated in the surface of the hollow fiber membrane 21 may be efficiently eliminated.

In addition, as the cross-section of the inner part of the housing 20 is reduced by the protrusion part 70, the density of the hollow fiber membrane 21 is increased by 2% at an area at which the protrusion part 70 is formed. Therefore, the falling of the hollow fiber membrane 21 may be prevented without providing an additional element.

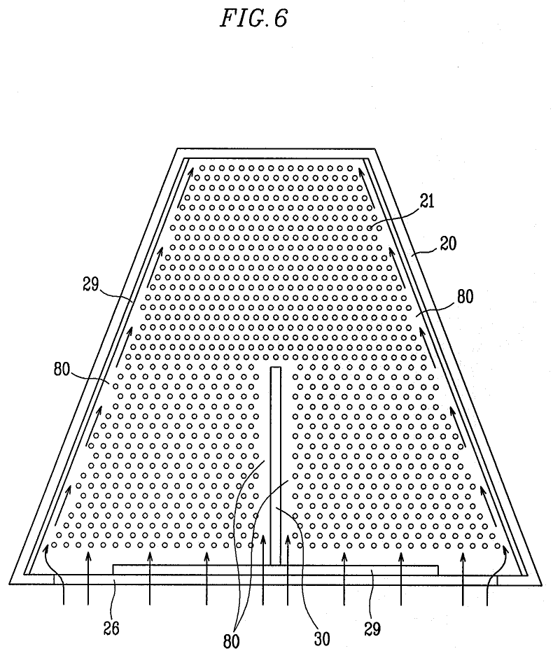

Further, as shown in FIG. 6, the small module 11 includes the central diffusing plate 30 provided inside the housing 20 and a path 80 for flowing the source water between the lateral diffusing plate 29 and the hollow fiber membrane 21.

The width of the path 80 is 3 to 5 mm.

Since the path 80 is provided between the diffusing plates 29 and 30 and the hollow fiber membrane 21, the source water flowing through the source water inlet of the housing 20 may flow further deeply inside the housing 20 through the path 80.

The path 80 that is an empty space is formed between the diffusing plates 29 and 30 and the hollow fiber membrane 21 since the hollow fiber membrane 21 is positioned apart from the respective diffusing plates 29 and 30.

In the exemplary embodiment of the present invention, as shown in FIG. 6, the small module having one central diffusing plate 30 is exemplified, but it is not limited thereto, and two or more central diffusing plates may be disposed with respective intervals.

In addition, the hollow fiber membrane 21 is required to be fixed to the fixing part of the housing unit 20 while being apart from the lateral diffusing plate 29 to form the path 80. A method for forming the path 80 will now be described.

Firstly, the hollow fiber membrane 21 is fixed to the fixing part of the housing 20 by using a temporary fixing agent.

The temporary fixing agent is liquefied at its melting point, is poured to the housing through the upper part thereof, and is applied to have a predetermined height. Then, a bundle of the hollow fiber membranes 21 already fixed by the temporary fixing agent is disposed on the liquefied temporary fixing agent, the temporary fixing agent is hardened, and the bundle is fixed.

When the temporary fixing agent is hardened, auxiliary units for forming a gap between the hollow fiber membrane 21 and the respective diffusing plates 29 and 30 are provided to the central diffusing plate 30 and lateral diffusing plate 29 of the housing 20.

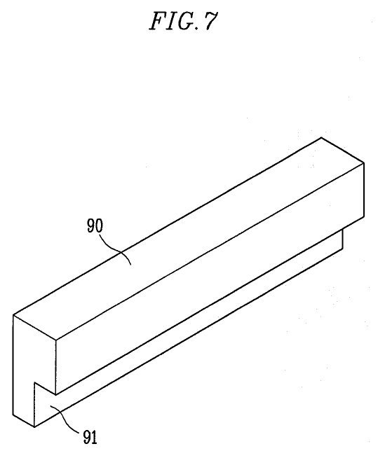

The auxiliary unit is classified into an auxiliary unit 90 for the lateral diffusing plate and an auxiliary unit 92 for the central diffusing plate. As shown in FIG. 7, the auxiliary unit 90 for the lateral diffusing plate is formed to correspond to a length of the lateral diffusing plate 29 provided to the lateral wall of the housing 20 and is provided on the lateral diffusing plate 29. On an inner side surface of the auxiliary unit 90, a gap maintaining member 91 having a width corresponding to the path 80 and extending to the lower part of the lateral diffusing plate 29 is provided.

The width of the gap maintaining member 91 is formed to correspond to the width of the path 80, and the gap maintaining member 91 may extend so as to not be interrupted by a permanent fixing agent.

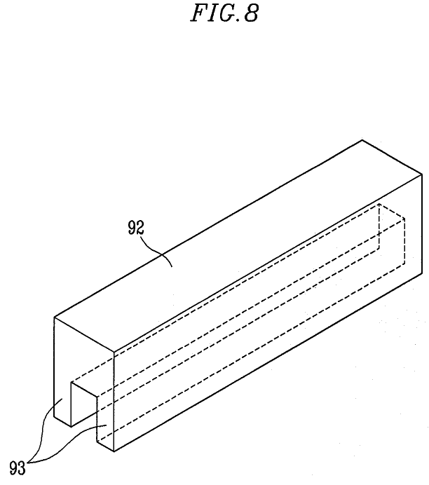

FIG. 8 is a perspective view representing an auxiliary unit provided to the central diffusing plate. The auxiliary unit 92 is formed in a bar shape corresponding to a length of the central diffusing plate 30. A groove to which the central diffusing plate 30 is inserted is formed in a lower part of the auxiliary unit 92, and both sides of the groove extend along both side surfaces of the central diffusing plate 30 to form the gap maintaining member 93 having a width corresponding to the path 80.

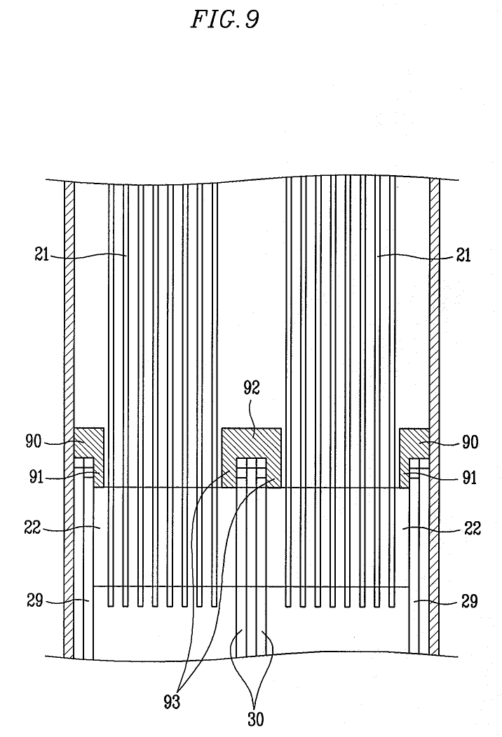

Accordingly, as shown in FIG. 9, when the respective auxiliary units 90 and 92 are mounted on the respective diffusing plates 29 and 30, the gap maintaining members 91 and 93 are positioned between the diffusing plates 29 and 30 and the hollow fiber membrane 21 to separate the diffusing plates 29 and 30 and the hollow fiber membrane 21.

In this state, the permanent fixing agent is provided on the temporary fixing agent, and is hardened to fix the hollow fiber membrane 21.

The permanent fixing agent is provided under the lower part of the gap maintaining member of the auxiliary unit so that the auxiliary unit may not touch the permanent fixing agent.

When the permanent fixing agent is hardened, the temporary fixing agent is eliminated, and the auxiliary units 90 and 92 are eliminated from the respective diffusing plates 29 and 30. Therefore, the path 80 may be formed between the diffusing plates 29 and 30 and the hollow fiber membrane 21.

That is, when the auxiliary units 90 and 92 are eliminated, the gap maintaining members 91 and 93 positioned between the hollow fiber membrane 21 and the diffusing plates 29 and 30 are eliminated, and an empty space corresponding to widths of the gap maintaining members 91 and 93 is formed between the hollow fiber membrane 21 and the diffusing plates 29 and 30. The empty space is sequentially formed along the diffusing plates 29 and 30 to form one path 80.

An operation of the exemplary embodiment of the present invention will now be described. Waste water flows into the housing 20 of each small module 11 through the source water inlet 26 of the housing 20, and then it is filtered by the hollow fiber membrane 21 of each small module 11. The filtered water is gathered in the collector 23 (communicated to the inner path of the hollow fiber membrane 21) of each small module 11, it flows into the central water pipe 12 through the connecting hole 27 of the housing 20 and the inlet 13 of the central water pipe 12, and it is then exhausted through the central water pipe 12.

In the above process, the source water flowing into the housing 20 through the source water inlet 26 may flow deeply inside the housing 20 through the path 80 formed between the diffusing plates 29 and 30 and the hollow fiber membrane 21.

Since the path 80 extends deeply inside the housing 20 along the respective diffusing plates 29 and 30, the source water quickly flows into the housing 20, and the hollow fiber membrane 21 positioned in the housing 20 may appropriately perform a role as an isolation layer.

Air supplied through the central air pipe 14 is supplied to the diffusing unit 28 of each small module 11 through the outlet 15 formed in the lower part of the central water pipe 12, and the air flowing through the main path 28 of each diffusing unit 24 is ejected to the inside of the housing 20 through the lateral diffusing plate 29 and the central diffusing plate 30 (connected to the main path 28) and the ejecting hole 31 formed in each diffusing plate.

The air vibrates the hollow fiber membrane 21 by going up in the housing 20, and whisks away the pollutants attached on the hollow fiber membrane 21.

In this case, the air ejected through the ejecting hole 31 of the lateral diffusing plate 29 goes up and is induced by the protrusion part 70 to flow into the inside of the housing 20. In addition, the source water passes the housing 20 having a cross-section narrowed by the protrusion part 70, and therefore the flow velocity is increased.

Accordingly, the pollutants on the surface of the entire hollow fiber membrane 21 in the housing 20 may be further efficiently eliminated by the fast flow velocity and the air induced to flow into the center of the housing 20.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, since the air is induced to flow into the hollow fiber membrane and the flow velocity is increased, the pollutants attached on the surface of the hollow fiber membrane surface may be efficiently eliminated.

In addition, since the upper part of the hollow fiber membrane may be supported without an additional unit, the falling of the hollow fiber membrane having a simplified configuration may be reduced.

Further, since the source water flows quickly and smoothly into the deep inside of the housing, each hollow fiber membrane may appropriately perform a role as an isolation layer, the water treatment efficiency is increased, and the contamination of the hollow fiber membrane caused by source water stagnation may be reduced.

Accordingly, waste water including pollutants, such as particle materials and organic materials that problematically affect the water flow, may be further efficiently treated.

1. A hollow fiber membrane module comprising:
a central water pipe including a plurality of inlets formed along a circumference of the central water pipe to flow water through the central water pipe; a central air pipe vertically provided in the central water pipe, extending to a lower surface of the central water pipe, and including a plurality of outlets formed along a circumference of the central air pipe to flow air through the central air pipe; and a plurality of small modules comprising a plurality of housings vertically provided with the central water pipe, connected to the inlet and the outlet, and arranged along an external circumferential surface of the central water pipe, a hollow fiber membrane provided in the respective housings and performing water treatment by a pressure difference, a fixing part for fixing a lower part of the hollow fiber membrane to the housing, a collector formed in a lower part of the housing and communicated with an inner path of the hollow fiber membrane to collect water treated by the hollow fiber membrane and flow it to the inlet, and a diffusing unit including a lateral diffusing plate that is provided on an inner wall of the housing and that has an ejecting hole for ejecting air and a central diffusing plate that extends from the inner wall of the housing to a center of the housing and has an ejecting hole for ejecting the air, the diffusing unit communicated with the outlet to eject the air to the hollow fiber membrane, wherein an inner side surface of an upper part of the housing is protruded inside the housing to form a protrusion part.

2. The hollow fiber membrane module of claim 1, wherein the protrusion part is formed by increasing a thickness of the inner side surface of the housing while maintaining an outer shape of the housing.

3. The hollow fiber membrane module of claim 1, wherein a lateral surface of the housing is formed by a step machining process to form the protrusion part.

4. The hollow fiber membrane module of claim 2, wherein a slope is formed between the inner side surface of the housing and the protrusion part.

5. The hollow fiber membrane module of claim 1, wherein the protrusion part is protruded at least to be greater than a thickness of the lateral diffusing plate.

6. The hollow fiber membrane module of claim 1, wherein the protrusion part is formed such that a ratio of a cross-section of the housing in which the protrusion part is not formed on the inner side surface to the cross-section of the housing in which the protrusion part is formed is 80 to 95%.

7. The hollow fiber membrane module of claim 1, wherein a path for inducing a flow of source water is formed between the respective diffusing plates and the hollow fiber membrane in the housing.

8. The hollow fiber membrane module of claim 1, wherein the ejecting hole is formed on a lateral surface of each diffusing plate to horizontally eject air to the vertically positioned hollow fiber membrane.

9. A hollow fiber membrane module comprising:
a central water pipe including a plurality of inlets formed along a circumference of the central water pipe to flow water through the central water pipe; a central air pipe vertically provided in the central water pipe, extending to a lower surface of the central water pipe, and including a plurality of outlets formed along a circumference of the central air pipe to flow air through the central air pipe; and a plurality of small modules comprising a plurality of housings vertically provided with the central water pipe, connected to the inlet and the outlet, and arranged along an external circumferential surface of the central water pipe, a hollow fiber membrane provided in the respective housings and performing water treatment by a pressure difference, a fixing part for fixing a lower part of the hollow fiber membrane to the housing, a collector formed in a lower part of the housing and communicated with an inner path of the hollow fiber membrane to collect water treated by the hollow fiber membrane and flow it to the inlet, and a diffusing unit including a lateral diffusing plate that is provided on an inner wall of the housing and that has an ejecting hole for ejecting air and a central diffusing plate that extends from the inner wall of the housing to a center of the housing and has an ejecting hole for ejecting the air, the diffusing unit communicated with the outlet to eject the air to the hollow fiber membrane, wherein a path for inducing a flow of source water is formed between the respective diffusing plates and the hollow fiber membrane in the housing.

10. A method for manufacturing a small module, the method comprising: fixing a hollow fiber membrane to a housing by using a temporary fixing agent; inserting an auxiliary unit having a width corresponding to a path between respective diffusing plates and a hollow fiber membrane of the housing; providing a permanent fixing agent between the temporary fixing agent and the auxiliary unit, and hardening the permanent fixing agent; eliminating the temporary fixing agent; and eliminating the auxiliary unit.

11. The method of claim 10, wherein the auxiliary unit is formed in a bar shape corresponding to a length of the diffusing plate, and it includes a gap maintaining member extending along both side surfaces of the hollow fiber membrane and the diffusing plate and having the width corresponding to the path.
